(19) United States
(12) Patent Application Publication
(10) Pub. No.: US 2016/0210463 A1
(43) Pub. Date: Jul. 21, 2016

(54) METHOD AND APPARATUS FOR UTILITY-AWARE PRIVACY PRESERVING MAPPING THROUGH ADDITIVE NOISE

(71) Applicants: Nadia FAWAZ, Santa Clara, CA (US); Abbasali Makhdoumi KAKHAKI, Somerville, MA (US); THOMSON LICENSING, Issy -les-Moulineaux (FR)

(72) Inventors: Nadia Fawaz, Santa Clara, CA (US); Abbasali Makhdoumi Kakhaki, Somerville, MA (US)

(21) Appl. No.: 14/912,701

(22) PCT Filed: Nov. 21, 2013
(86) PCT No.: PCT/US2013/071290

§ 371 Date: Feb. 18, 2016

Related U.S. Application Data
(60) Provisional application No. 61/867,546, filed on Aug. 19, 2013.

(51) Int. Cl. G06F 21/62; G06F 21/60

(52) U.S. Cl. CPC G06F 21/62; G06F 21/604

(57) ABSTRACT

The present embodiments focus on the privacy-utility tradeoff encountered by a user who wishes to release some public data (denoted by X) to an analyst, that is correlated with his private data (denoted by S), in the hope of getting some utility. When noise is added as a privacy preserving mechanism, that is, Y=X+N, where Y is the actual released data to the analyst and N is noise, we show that adding Gaussian noise is optimal under 1_2-norm distortion for continuous data X. We denote the mechanism of adding Gaussian noise that minimizes the worst-case information leakage by Gaussian mechanism. The parameters for Gaussian mechanism are determined based on the eigenvectors and eigenvalues of the covariance of X. We also develop a probabilistic privacy preserving mapping mechanism for discrete data X, wherein the random discrete noise follows a maximum-entropy distribution.

### CROSS-REFERENCE TO RELATED APPLICATIONS

This application claims the benefit of the filing date of the following U.S. Provisional Application, which is hereby incorporated by reference in its entirety for all purposes: Ser. No. 61/867,546, filed on Aug. 19, 2013, and titled “Method and Apparatus for Utility-Aware Privacy Preserving Mapping through Additive Noise.”

This application is related to U.S. Provisional Patent Application Ser. No. 61/691,090 filed on Aug. 20, 2012, and titled “A Framework for Privacy against Statistical Inference” (hereinafter “Fawaz”). The provisional application is expressly incorporated by reference herein in its entirety.

In addition, this application is related to the following applications: (1) Attorney Docket No. PU130120, entitled “Method and Apparatus for Utility-Aware Privacy Preserving Mapping against Inference Attacks,” and (2) Attorney Docket No. PU130121, entitled “Method and Apparatus for Utility-Aware Privacy Preserving Mapping in View of Collusion and Composition,” which are commonly assigned, incorporated by reference in their entireties, and concurrently filed herewith.

### TECHNICAL FIELD

This invention relates to a method and an apparatus for preserving privacy, and more particularly, to a method and an apparatus for adding noise to user data to preserve privacy.

### BACKGROUND

In the era of Big Data, the collection and mining of user data has become a fast growing and common practice by a large number of private and public institutions. For example, technology companies exploit user data to offer personalized services to their customers, government agencies rely on data to address a variety of challenges, e.g., national security, national health, budget and fund allocation, or medical institutions analyze data to discover the origins and potential cures to diseases. In some cases, the collection, the analysis, or the sharing of a user's data with third parties is performed without the user's consent or awareness. In other cases, data is released voluntarily by a user to a specific analyst, in order to get a service in return, e.g., product ratings released to get recommendations. This service, or other benefit that the user derives from allowing access to the user's data may be referred to as utility. In either case, privacy risks arise as some of the collected data may be deemed sensitive by the user, e.g., political opinion, health status, income level, or may seem harmless at first sight, e.g., product ratings, yet lead to the inference of more sensitive data with which it is correlated. The latter threat refers to an inference attack, a technique of inferring private data by exploiting its correlation with publicly released data.

### SUMMARY

The present principles provide a method for processing user data for a user, comprising the steps of: accessing the user data, which includes private data and public data, the private data corresponding to a first category of data, and the public data corresponding to a second category of data; determining a covariance matrix of the first category of data; generating a Gaussian noise responsive to the covariance matrix; modifying the public data by adding the generated Gaussian noise to the public data of the user; and releasing the modified data to at least one of a service provider and a data collecting agency as described below. The present principles also provide an apparatus for performing these steps.

The present principles also provide a method for processing user data for a user, comprising the steps of: accessing the user data, which includes private data and public data; accessing a constraint on utility D, the utility being responsive to the public data and released data of the user; generating a random noise Z responsive to the utility constraint, the random noise follows a maximum entropy probability distribution under the utility constraint; and adding the generated noise to the public data of the user to generate the released data for the user as described below. The present principles also provide an apparatus for performing these steps.

The present principles also provide a computer readable storage medium having stored thereon instructions for processing user data for a user according to the methods described above.

### BRIEF DESCRIPTION OF THE DRAWINGS

FIG. 1 is a flow diagram depicting an exemplary method for preserving privacy by adding Gaussian noise to continuous data, in accordance with an embodiment of the present principles.

FIG. 2 is a flow diagram depicting an exemplary method for preserving privacy by adding discrete noise to discrete data, in accordance with an embodiment of the present principles.

FIG. 3 is a block diagram depicting an exemplary privacy agent, in accordance with an embodiment of the present principles.

FIG. 4 is a block diagram depicting an exemplary system that has multiple privacy agents, in accordance with an embodiment of the present principles.

### DETAILED DESCRIPTION

We consider the setting described in Fawaz, where a user has two kinds of data that are correlated: some data that he would like to remain private, and some non-private data that he is willing to release to an analyst and from which he may derive some utility, for example, the release of media preferences to a service provider to receive more accurate content recommendations.

The term analyst, which for example may be a part of a service provider's system, as used in the present application, refers to a receiver of the released data, who ostensibly uses the data in order to provide utility to the user. The analyst is a legitimate receiver of the released data. However, an analyst could also illegitimately exploit the released data and infer some information about private data of the user. This creates a tension between privacy and utility requirements. To reduce the inference threat while maintaining utility the user may release a “distorted version” of data, generated according to a conditional probabilistic mapping, called “privacy preserving mapping,” designed under a utility constraint.

In the present application, we refer to the data a user would like to remain private as “private data,” the data the user is willing to release as “public data,” and the data the user actually releases as “released data.” For example, a user may want to keep his political opinion private, and is willing to release his TV ratings with modification (for example, the user's actual rating of a program is 4, but he releases the rating as 3). In this case, the user's political opinion is considered to be private data for this user, the TV ratings are considered to be public data, and the released modified TV ratings are considered to be the released data. Note that another user may be willing to release both political opinion and TV ratings without modifications, and thus, for this other user, there is no distinction between private data, public data and released data when only political opinion and TV ratings are considered. If many people release political opinions and TV ratings, an analyst may be able to derive the correlation between political opinions and TV ratings, and thus, may be able to infer the political opinion of the user who wants to keep it private.

Regarding private data, this refers to data that the user not only indicates that it should not be publicly released, but also that he does not want it to be inferred from other data that he would release. Public data is data that the user would allow the privacy agent to release, possibly in a distorted way to prevent the inference of the private data.

In one embodiment, public data is the data that the service provider requests from the user in order to provide him with the service. The user however will distort (i.e., modify) it before releasing it to the service provider. In another embodiment, public data is the data that the user indicates as being “public” in the sense that he would not mind releasing it as long as the release takes a form that protects against inference of the private data.

As discussed above, whether a specific category of data is considered as private data or public data is based on the point of view of a specific user. For ease of notation, we call a specific category of data as private data or public data from the perspective of the current user. For example, when trying to design privacy preserving mapping for a current user who wants to keep his political opinion private, we call the political opinion as private data for both the current user and for another user who is willing to release his political opinion.

In the present principles, we use the distortion between the released data and public data as a measure of utility. When the distortion is larger, the released data is more different from the public data, and more privacy is preserved, but the utility derived from the distorted data may be lower for the user. On the other hand, when the distortion is smaller, the released data is a more accurate representation of the public data and the user may receive more utility, for example, receive more accurate content recommendations.

In one embodiment, to preserve privacy against statistical inference, we model the privacy-utility tradeoff and design the privacy preserving mapping by solving an optimization problem minimizing the information leakage, which is defined as mutual information between private data and released data, subject to a distortion constraint.

In Fawaz, finding the privacy preserving mapping relies on the fundamental assumption that the prior joint distribution that links private data and released data is known and can be provided as an input to the optimization problem. In practice, the true prior distribution may not be known, but rather some prior statistics may be estimated from a set of sample data that can be observed. For example, the prior joint distribution could be estimated from a set of users who do not have privacy concerns and publicly release different categories of data, which may be considered to be private or public data by the users who are concerned about their privacy. Alternatively when the private data cannot be observed, the marginal distribution of the public data to be released, or simply its second order statistics, may be estimated from a set of users who only release their public data. The statistics estimated based on this set of samples are then used to design the privacy preserving mapping mechanism that will be applied to new users, who are concerned about their privacy. In practice, there may also exist a mismatch between the estimated prior statistics and the true prior statistics, due for example to a small number of observable samples, or to the incompleteness of the observable data.

To formulate the problem, the public data is denoted by a random variable X∈ [symbol] with the probability distribution P_{X}. X is correlated with the private data, denoted by random variable S∈ [symbol] . The correlation of S and X is defined by the joint distribution P_{S,X}. The released data, denoted by random variable Y∈ [symbol] is a distorted version of X. Y is achieved via passing X through a kernel, P_{Y|X}. In the present application, the term “kernel” refers to a conditional probability that maps data X to data Y probabilistically. That is, the kernel P_{Y|X} is the privacy preserving mapping that we wish to design. Since Y is a probabilistic function of only X, in the present application, we assume S→X→Y form a Markov chain. Therefore, once we define P_{Y|X}, we have the joint distribution P_{S,X,Y}=P_{Y|X}P_{S,X} and in particular the joint distribution P_{S,Y}.

In the following, we first define the privacy notion, and then the accuracy notion.

Definition 1. Assume S→X→Y. A kernel P_{Y|X} is called ε-divergence private if the distribution P_{S,Y} resulting from the joint distribution P_{S,X,Y}=P_{Y|X}P_{S,X} satisfies

$$D ( {P}_{S , Y} \vert \vert {P}_{S} {P}_{Y} ) {=}^{Δ} {𝔼}_{S , Y} [ log \frac{P ( S \vert Y )}{P ( S )} ] {=}^{Δ} I ( S ; Y ) = ε H ( S ) , \qquad ( 1 )$$

where D(.) is the K-L divergence, [symbol] (.) is the expectation of a random variable, H(.) is the entropy, ε∈[0,1] is called the leakage factor, and the mutual information I(S; Y) represents the information leakage.

We say a mechanism has full privacy if ε=0. In extreme cases, ε=0 implies that, the released random variable, Y, is independent from the private random variable, S, and ε=1 implies that S is fully recoverable from Y (S is a deterministic function of Y). Note that one can assume Y is completely independent from S to have full privacy (ε=0), but, this may lead to a poor accuracy level. We define accuracy as the following.

Definition 2. Let d: [symbol] × [symbol] → [symbol] ⁺ be a distortion measure. A kernel P_{Y|X} is called D-accurate if [symbol] [d(X, Y)]≦D.

There is a tradeoff between leakage factor, ε, and distortion level, D, of a privacy preserving mapping.

The present principles propose methods to design utility-aware privacy preserving mapping mechanisms when only partial statistical knowledge of the prior is available. More specifically, the present principles provide privacy preserving mapping mechanisms in the class of additive noise mechanisms, wherein noise is added to public data before it is released. In the analysis, we assume the mean value of the noise to be zero. The mechanism can also be applied when the mean is not zero. In one example, the results are the same for non-zero means because entropy is not sensitive to mean. The mechanisms require only knowledge of second order moments of the data to be released for both continuous and discrete data.

### Gaussian Mechanism

In one embodiment, we consider continuous public data X and privacy preserving mapping schemes that are achieved by adding noise to the signal, i.e., Y=X+N. Exemplary continuous public data may be the height or blood pressure of a user. The mapping is obtained by knowing VAR(X) (or covariance matrix in the case of multi-dimensional X), without knowing P_{X} and P_{S,X}. First, we show that among all privacy preserving mapping mechanisms when noise is added to public data to preserve privacy, adding Gaussian noise is optimal.

Since S→X→Y, we have I(S; Y)≦I(X; Y). In order to bound the information leakage, I(S; Y), we bound I(X; Y). If X=ƒ(S) is a deterministic function of S, then I(S; Y)=I(X; Y) and the bound is tight (this happens for instance in linear regression when X=AS for some matrix A).

Let X∈ [symbol] ⁿ. Denote the covariance matrix of X by C_{X}. Let Y=X+N, where N is a noise independent from X, with mean 0 and covariance matrix C_{N}. Note that we use the notation of variance (σ_{N}²) when there is only one random variable, and covariance (C_{N}) when there are multiple ones. We have the following result.

Proposition 2. Assume P_{X} is unknown in the design of privacy preserving mapping and we only know VAR(X)≧σ_{X}² for some σ_{X}. Also consider the class of privacy preserving schemes obtained by adding independent noise, N, to the signal, X. The noise has zero mean and variance (l₂-norm distortion) not greater than σ_{N}² for some σ_{N}. We show that, Gaussian noise is the best, in the following sense:

[symbol]

I(X; X+N_{G})≦ [symbol] I(X; X+N), (15)

where N_{G} represents Gaussian noise and N is a random variable such that [symbol] [N_{G}]= [symbol] [N]=0 and VAR(N_{G})=VAR(N)=σ_{N}². This implies that, the worst-case information leakage using N_{G} is not greater than worst-case information leakage using N.

Proof: Using Gaussian saddle point theorem, we have

$${max}_{{P}_{X} \text{:} X ∐ {N}_{G} , VAR ( X ) \leq {σ}_{X}^{2}} I ( X ; X + {N}_{G} ) = I ( {X}_{G} ; {X}_{G} + {N}_{G} ) \leq I ( {X}_{G} ; {X}_{G} + N ) \leq {max}_{{P}_{X} \text{:} X ∐ {N}_{G} , VAR ( X ) \leq {σ}_{X}^{2}} I ( X ; X + N ) , \qquad ( 16 )$$

where X_{G} has Gaussian distribution with zero mean and variance [symbol] _{X}². This completes the proof.□

Now we know that when noise is added to preserve privacy, adding Gaussian noise is the optimal solution in the family of additive noises, under l₂-norm distortion constraint. In the following, we determine the optimal parameters for the Gaussian noise to be added to the public data. We denote the mechanism of adding Gaussian noise at such parameters by Gaussian mechanism.

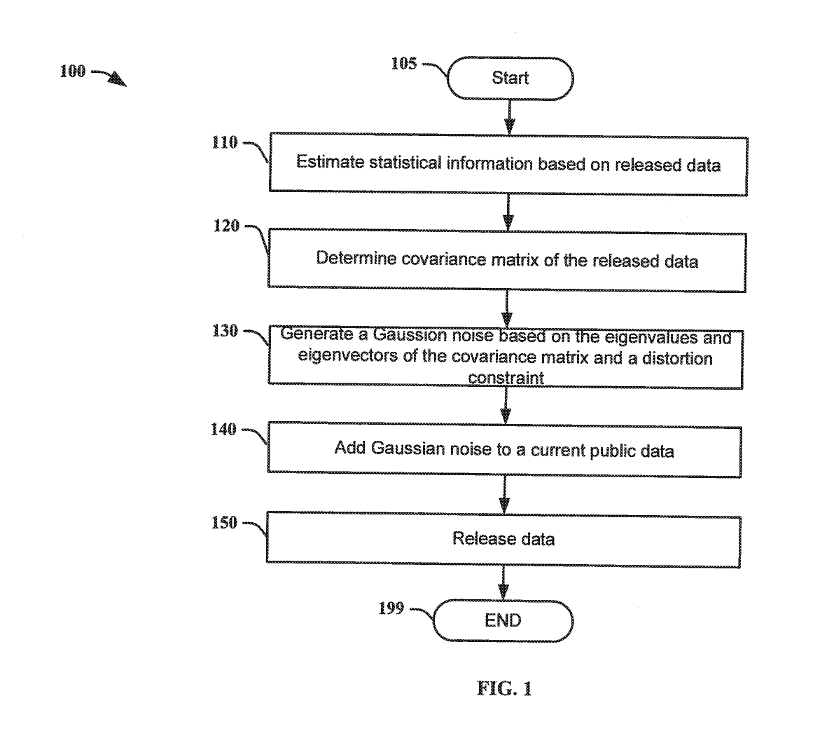

In one exemplary embodiment, for a given C_{X} and distortion level, D, Gaussian mechanism proceeds by steps as illustrated in FIG. 1.

Method 100 starts at 105. At step 110, it estimates statistical information based on public data released by users who are not concerned about privacy of their public data or private data. We denote these users as “public users,” and denote the users who are concerned about the privacy of their private data as “private users.”

The statistics may be collected by crawling the web, accessing different databases, or may be provided by a data aggregator, for example, by bluekai.com. Which statistical information can be gathered depends on what the public users release. Note that it requires less data to characterize the variance than to characterize the marginal distribution P. Hence we may be in a situation where we can estimate the variance, but not the marginal distribution accurately. In one example, we may only be able to get the mean and variance (or covariance) of the public data at step 120 based on the collected statistical information.

At step 130, we take the eigenvalue decomposition of covariance matrix C_{X}. The covariance matrix of the Gaussian noise, N_{G}, has eigenvectors same as the eigenvectors of C_{X}. Moreover, the corresponding eigenvalues of C_{N} are given by solving the following optimization problem

$${min}_{{σ}_{i} : 1 \leq i \leq n} {\prod }_{i = 1}^{n} \frac{{σ}_{i} + {λ}_{i}}{{σ}_{i}} \\ s . t . {\sum }_{i = 1}^{n} {σ}_{i} \leq D , \qquad ( 17 )$$

where λᵢs and σⁱs (1≦λᵢ≦n) denote the eigenvalues of C_{X} and C_{N}, respectively. From the determined eigenvectors and eigenvalues, we can then determine covariance matrix C_{N} for the Gaussian noise, through its eigendecomposition. Subsequently, we can generate the Gaussion noise N_{G}˜ [symbol] (0, C_{N}). The distortion is given by Σᵢ₌₁ⁿ [symbol] [(Yᵢ−Xᵢ)²]=tr(C_{N})=Σᵢ₌₁ⁿσᵢ≦D, wherein tr( ) denotes the sum of the diagonal elements and n is the dimension of vector X.

At step 140, the Gaussian noise is added to public data, that is, Y=X+N_{G}. The distorted data is then released to, for example, a service provider or a data collecting agency, at step 150. Method 100 ends at step 199.

In the following theorem we prove that, the proposed Gaussian mechanism is optimal under l₂-norm distortion constraint.

Theorem 3. Assuming l₂-norm distortion and a given distortion level, D, the optimum Gaussian noise in the Gaussian mechanism that minimizes mutual information, satisfies:

the covariance matrix of the optimum noise, N_{G}, has eigenvectors same as the eigenvectors of C_{X}. Also, the eigenvalues are given in (17).

Proof: We have

$$I ( X ; X + N ) \leq \frac{1}{2} log ( \frac{\vert {C}_{X} + {C}_{N} \vert}{\vert {C}_{N} \vert} ) , \qquad ( 18 )$$

where the inequality comes from Theorem 8.6.5 of a book by T. M. Cover and J. A. Thomas, “Elements of information theory,” Wiley-interscience, 2012. Since we do not know the distribution of X, we must minimize the upper bound

$$\frac{1}{2} log ( \frac{\vert {C}_{X} + {C}_{N} \vert}{\vert {C}_{N} \vert} ) ,$$

because it is achievable with Gaussian X. Consider the eigenvalue decomposition of the semidefinite matrix C_{X}, to obtain C_{X}=QΛQ^{t}, where QQ^{t}=I and Λ is a diagonal matrix containing the eigenvalues of C_{X}. We have [symbol] [Σᵢ₌₁^{k}(Yᵢ−Xᵢ)²]=tr(C_{N})=tr(Q^{t}C_{N}Q)=Σσᵢ≦D and the optimization problem becomes

$${min}_{{C}_{N}} \frac{\vert Λ + {Q}^{t} {C}_{N} Q \vert}{\vert {Q}^{t} {C}_{N} Q \vert} , s . t . tr ( {Q}^{t} {C}_{N} Q ) \leq D .$$

Without loss of generality, assume λ₁≧ . . . ≧λₙ. Let σ₁≧ . . . ≧σₙ be the eigenvalues of Q^{t}C_{N}Q^{t}. According to Theorem 1 of an article by M. Fiedler, “Bounds for the determinant of the sum of Hermitian matrices,” Proceedings of the American Mathematical Society, we have |Λ+Q^{t}C_{N}Q|≧Π(λᵢ+σᵢ) and the equality holds if Q^{t}C_{N}Q is a diagonal matrix. Therefore, using a diagonal matrix with the same eigenvalues, σᵢs, we achieve the same distortion level and a smaller leakage, which contradicts optimality. Thus, Q^{t}C_{N}Q is a diagonal matrix.□

### Example 3

Assume X is a deterministic real-valued function of S, X=ƒ(S) and that, VAR(X)=σ_{X}¹. Because of S→X→Y, we have I(X; Y)=I(S; Y). Let N˜ [symbol] N(0, σ_{N}²) and Y=X+N. For any ε, we can achieve (ε, D)-divergence-distortion privacy, where

$$D = \frac{{σ}_{X}^{2}}{{e}^{2 ε H ( S )} - 1} .$$

Note 1. This analysis works only for ε>0. Once we want to have perfect privacy, i.e., ε=0, then this scheme chooses σ_{N}²=28 . In practice, this means that, Y is independent from X. If we assume Y= [symbol] [X] (a deterministic value), then I(Y; S)=0 and [symbol] [d(X, Y)]=VAR(X). Therefore, For distortion level greater than or equal to VAR(X), the deterministic mechanism that sets Y= [symbol] [X] achieves ε=0.

### Example 5

It can be shown that, by adding Gaussian noise with variance

$${σ}_{N}^{2} \geq \frac{1}{{ε}^{2}} 2 log ( 2 / δ )$$

we can achieve (ε, δ) differential privacy. This scheme results in a distortion

$$D \geq \frac{1}{{ε}^{2}} 2 log ( 2 / δ )$$

and the leakage of information

$$L \leq \frac{1}{2} log ( 1 + \frac{{σ}_{X}^{2}}{\frac{1}{{ε}^{2}} 2 log ( 2 / δ )} ) .$$

A qualitative way for comparison is to state that: Using (ε, δ) differential privacy Gaussian mechanism, we would require a large distortion to achieve a small leakage. On the other hand, using a divergence privacy Gaussian mechanism according to the present principles, a scheme that leaks L bits with minimum distortion, D, achieves any (ε, δ)-differential privacy, where

$$\frac{1}{{ε}^{2}} 2 log ( \frac{2}{δ} ) = \frac{{σ}_{X}^{2}}{{e}^{2 L} - 1} .$$

### Discrete Mechanism

In another embodiment, we consider discrete random variable, X, where [symbol] = [symbol] . Again, we bound I(X; Y) in order to bound I(S; Y). Let the distortion measure to be lₚ norm, i.e., the distortion between X and Y to be

$${𝔼 [ {\vert X - Y \vert}^{p} ]}^{\frac{1}{p}}$$

for some 1≦p≦∞.

Definition 5. For a given 1≦p≦∞, among all random variables with lₚ norm less than or equal to a given D, denote the distribution with the maximum entropy by P_{p,D}*. More formally, P_{p,D}* is the probability measure achieving the maximum objective function in the following optimization

$${max}_{{P}_{Z} : Z \sim {P}_{Z}} H ( z ) , s . t . {𝔼 [ {\vert Z \vert}^{p} ]}^{\frac{1}{p}} \leq D .$$

That is, the optimization problem is to located maximum entropy discrete probability distribution P_{p,D}*, subject to a constraint on the p^{th} moment. The maximum entropy is denoted by H*(p, D).

Next, we characterize P_{p,D}* and its entropy.

Proposition 3. For any 1≦p≦∞, P_{p,D}* is given by P_{p,D}*[Z=i]=AB^{-|i|}^{^{p}}, where A and B are chosen such that Σ_{i=-∞}^{∞}A B^{-|i|}^{^{p}}=1 and

$${𝔼 [ {\vert Z \vert}^{p} ]}^{\frac{1}{p}} = D .$$

Moreover, we have H*(p,D)=−log A+(log B)D^{p}.

Proof: Let Z˜AB^{-|i|}^{^{p}} and W˜P_{W} such that

$${𝔼 [ {\vert W \vert}^{p} ]}^{\frac{1}{p}} \leq D .$$

Since [symbol] _{P}_{_{W}}[|i|^{p}]≦D^{p}, we have

$$0 \leq D ( {P}_{W} ‖ {P}_{Z} ) = {𝔼}_{{P}_{W}} [ log \frac{{P}_{W}}{{P}_{Z}} ] = - H ( W ) - {𝔼}_{{P}_{W}} [ log A - ( log B ) {\vert i \vert}^{p} ] \leq - H ( W ) - log A + ( log B ) {𝔼}_{{P}_{Z}} [ {\vert i \vert}^{p} ] = - H ( W ) + H ( Z ) .$$

Therefore, H(Z)≧H(W) and H*(p,D)=−log A+(log B)D^{p.}

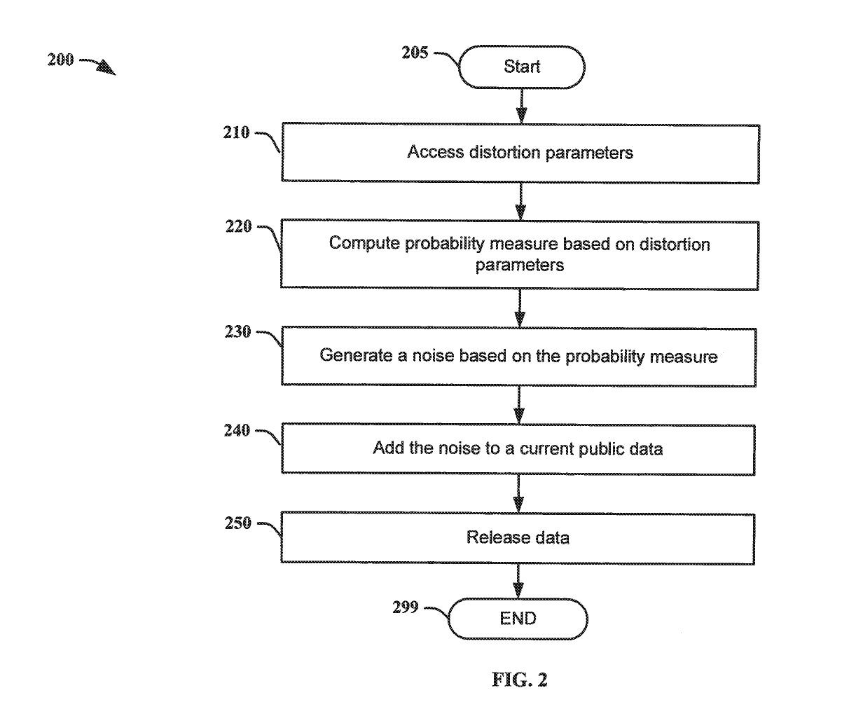

We denote the mechanism of adding noise Z˜P_{p,D}* to discrete public data by discrete mechanism. In one exemplary embodiment, discrete mechanism proceeds by steps as illustrated in FIG. 2.

Method 200 starts at 205. At step 210, it accesses parameters, for example, p and D, to define a distortion measure. For a given distortion measure lₚ (1≦p≦∞) and a distortion level, D, it computes a probability measure P_{p,D}* as given in Proposition 3 at step 220. Note that the distribution P_{p,D}* is only determined by p and D, but the resulting praivcy accuracy tradeoff will depend on X because the distortion constraint couples the privacy and the accuracy.

At step 230, a noise is generated according to the probability measure before it is added to the public data at step 240, that is, Y=X+Z, where Z˜P_{p,D}*. We have

$$d ( X , Y ) = {𝔼 [ {\vert Y - X \vert}^{p} ]}^{\frac{1}{p}} = {𝔼 [ {\vert Z \vert}^{p} ]}^{\frac{1}{p}} \leq D .$$

Method 200 ends at step 299.

Next, we analyze the mutual information, I(X; Y). Let

$${‖ X ‖}_{p} = {𝔼 [ {\vert X \vert}^{p} ]}^{\frac{1}{p}}$$

denote the lₚ norm of X. Using Minkowski's inequality, we have

$${𝔼 [ {\vert Y \vert}^{p} ]}^{\frac{1}{p}} = {𝔼 [ {\vert X + Z \vert}^{p} ]}^{\frac{1}{p}} \leq {𝔼 [ {\vert X \vert}^{p} ]}^{\frac{1}{p}} + {𝔼 [ {\vert Z \vert}^{p} ]}^{\frac{1}{p}} = {‖ X ‖}_{p} + D .$$

Therefore, we obtain

I(S; Y)≦I(X; Y)=H(X+Z)−H(Z)≦H*(p, ∥X∥ₚ+D)−H*(p,D).

That is, the privacy guarantee (i.e., information leakage) we obtain when using the discrete mechanism is upper-bounded by the right term, which depends both on D and the average lₚ norm of X.

The beauty of the additive noise technique is that not only it does not require much information about the statistics of X, let alone information about S, but it also reduces the optimization problem to a simple problem where all we need to design are the parameters of the noise, instead of having to specify a full kernel P_{Y|X}. This reduces considerably the size of the optimization, and thus its complexity and computational/memory requirements to resolve it.

Advantageously, without the knowledge of joint probability distribution P_{S,X} and only the knowledge of first-order and second-order moments of public data X, the present principles provide privacy preserving mapping mechanisms that preserve privacy by adding noise to public data, for both continuous and discrete data.

A privacy agent is an entity that provides privacy service to a user. A privacy agent may perform any of the following:
receive from the user what data he deems private, what data he deems public, and what level of privacy he wants;
compute the privacy preserving mapping;
implement the privacy preserving mapping for the user (i.e., distort his data according to the mapping); and
release the distorted data, for example, to a service provider or a data collecting agency.

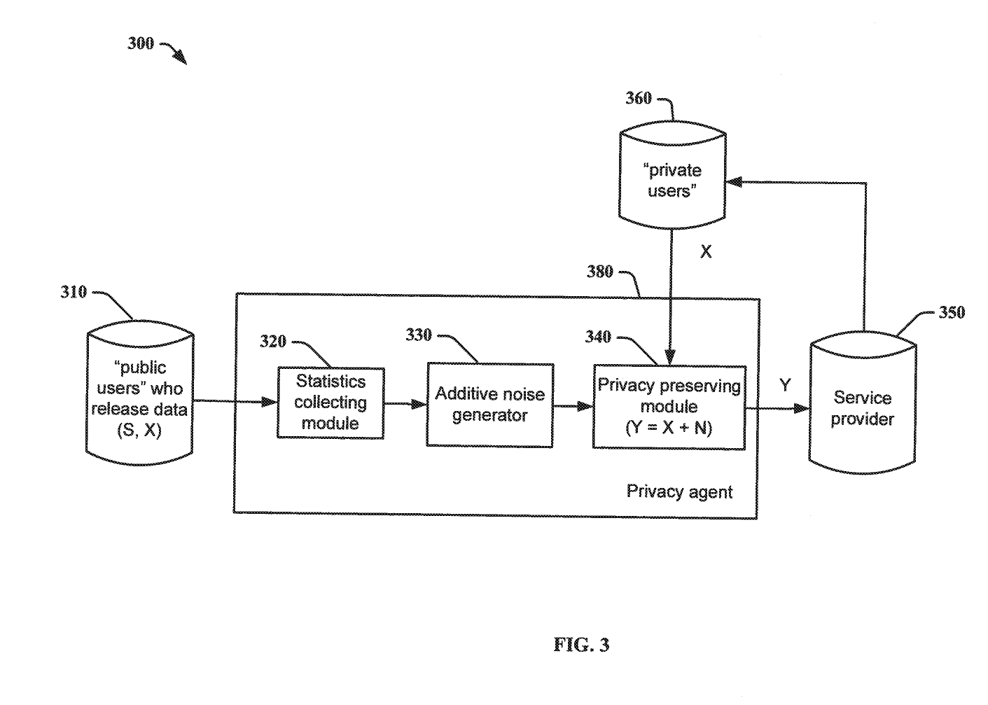

The present principles can be used in a privacy agent that protects the privacy of user data. FIG. 3 depicts a block diagram of an exemplary system 300 where a privacy agent can be used. Public users 310 release their private data (S) and/or public data (X). As discussed before, public users may release public data as is, that is, Y=X. The information released by the public users becomes statistical information useful for a privacy agent.

A privacy agent 380 includes statistics collecting module 320, additive noise generator 330, and privacy preserving module 340. Statistics collecting module 320 may be used to collect covariance of public data. Statistics collecting module 320 may also receive statistics from data aggregators, such as bluekai.com. Depending on the available statistical information, additive noise generator 330 designs a noise, for example, based on the Gaussian mechanism or discrete mechanism. Privacy preserving module 340 distorts public data of private user 360 before it is released, by adding the generated noise. In one embodiment, statistics collecting module 320, additive noise generator 330, and privacy preserving module 340 can be used to perform steps 110, 130, and 140 in method 100, respectively.

Note that the privacy agent needs only the statistics to work without the knowledge of the entire data that was collected in the data collection module. Thus, in another embodiment, the data collection module could be a standalone module that collects data and then computes statistics, and needs not be part of the privacy agent. The data collection module shares the statistics with the privacy agent. In one embodiment, additive noise generator 330, and privacy preserving module 340 can be used to perform steps 220 and 230 in method 200, respectively.

A privacy agent sits between a user and a receiver of the user data (for example, a service provider). For example, a privacy agent may be located at a user device, for example, a computer, or a set-top box (STB). In another example, a privacy agent may be a separate entity.

All the modules of a privacy agent may be located at one device, or may be distributed over different devices, for example, statistics collecting module 320 may be located at a data aggregator who only releases statistics to the module 330, the additive noise generator 330, may be located at a “privacy service provider” or at the user end on the user device connected to a module 320, and the privacy preserving module 340 may be located at a privacy service provider, who then acts as an intermediary between the user, and the service provider to who the user would like to release data, or at the user end on the user device.

The privacy agent may provide released data to a service provider, for example, Comcast or Netflix, in order for private user 360 to improve received service based on the released data, for example, a recommendation system provides movie recommendations to a user based on its released movies rankings.

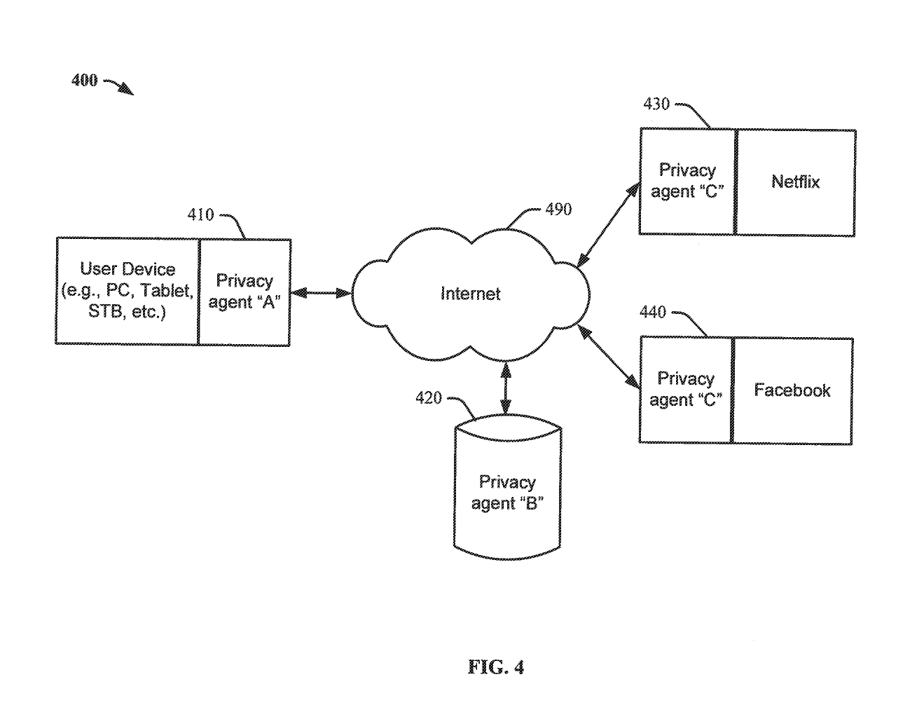

In FIG. 4, we show that there are multiple privacy agents in the system. In different variations, there need not be privacy agents everywhere as it is not a requirement for the privacy system to work. For example, there could be only a privacy agent at the user device, or at the service provider, or at both. In FIG. 4, we show that the same privacy agent “C” for both Netflix and Facebook. In another embodiment, the privacy agents at Facebook and Netflix, can, but need not, be the same.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for processing user data for a user, comprising:
accessing the user data, which includes private data and public data, the private data corresponding to a first category of data, and the public data corresponding to a second category of data;
determining a covariance matrix of the first category of data;
generating a Gaussian noise responsive to the covariance matrix;
modifying the public data by adding the generated Gaussian noise to the public data of the user; and
releasing the modified data to at least one of a service provider and a data collecting agency.

2. The method of claim 1, wherein the public data comprises data that the user has indicated can be publicly released, and the private data comprises data that the user has indicated is not to be publicly released.

3. The method of claim 1, wherein the step of generating a Gaussian noise comprises the steps of:
determining eigenvalues and eigenvectors of the covariance matrix; and
determining another eigenvalues and eigenvectors responsive to the determined eigenvalues and eigenvectors, respectively, wherein the Gaussian noise is generated responsive to the another eigenvalues and eigenvectors.

4. The method of claim 1, wherein the determined another eigenvectors are substantially same as the determined eigenvectors of the covariance matrix.

5. The method of claim 1, wherein the step of generating a Gaussian noise is further responsive to a distortion constraint.

6. The method of claim 1, wherein the step of generating a Gaussian noise comprises generating independently of information of the second category of data.

7. The method of claim 1, further comprising the step of:
receiving service based on the released data.

8. A method for processing user data for a user, comprising:
accessing the user data, which includes private data and public data;
accessing a constraint on utility D, the utility being responsive to the public data and released data of the user;
generating a random noise Z responsive to the utility constraint, the random noise follows a maximum entropy probability distribution under the utility constraint;
adding the generated noise to the public data of the user to generate the released data for the user; and
releasing the released data to at least one of a service provider and a data collecting agency.

9. The method of claim 8, wherein the random noise follows a distribution P[Z=i]=AB^{|i|}^{^{p}}, wherein A and B are chosen such that Σ_{i=-∞}^{∞}A B^{-|i|}^{^{p}}=1, wherein p is an integer.

10. The method of claim 9, wherein
$${𝔼 [ {\vert Z \vert}^{p} ]}^{\frac{1}{p}} = D .$$

11. An apparatus for processing user data for a user, comprising:
a statistical collecting module configured to determine a covariance matrix of a first category of data of the user data, which includes private data and public data, the private data corresponding to the first category of data, and the public data corresponding to a second category of data; and
an additive noise generator configured to generate a Gaussian noise responsive to the covariance matrix; and
a privacy preserving module configured to:
modify the public data by adding the generated Gaussian noise to the public data of the user, and
release the modified data to at least one of a service provider and a data collecting agency.

12. The apparatus of claim 11, wherein the public data comprises data that the user has indicated can be publicly released, and the private data comprises data that the user has indicated is not to be publicly released.

13. The apparatus of claim 11, wherein additive noise generator is configured to:
determine eigenvalues and eigenvectors of the covariance matrix, and
determine another eigenvalues and eigenvectors responsive to the determined eigenvalues and eigenvectors, respectively, wherein the Gaussian noise is generated responsive to the another eigenvalues and eigenvectors.

14. The apparatus of claim 11, wherein the determined another eigenvectors are substantially same as the determined eigenvectors of the covariance matrix.

15. The apparatus of claim 11, wherein additive noise generator is configured to be responsive to a distortion constraint.

16. The apparatus of claim 11, wherein the additive noise generator generates the Gaussian noise independently of information of the second category of data.

17. The apparatus of claim 11, further comprising a processor configured to receive service based on the released data.

18. An apparatus for processing user data for a user, comprising:
a statistics collecting module configured to access a constraint on utility D, the utility being responsive to public data and released data of the user;
an additive noise generator configured to generate a random noise Z responsive to the utility constraint, the random noise follows a maximum entropy probability distribution under the utility constraint; and
a privacy preserving module configured to:
access the user data, which includes private data and the public data,
add the generated noise to the public data of the user to generate the released data for the user, and
release the released data to at least one of a service provider and a data collecting agency.

19. The apparatus of claim 18, wherein the random noise follows a distribution P[Z=i]=AB^{-|i|}^{^{p}}, wherein A and B are chosen such that Σ_{i=-∞}^{∞}A B^{-|i|}^{^{p}}=1, wherein p is an integer.

20. The apparatus of claim 19, wherein
$${𝔼 [ {\vert Z \vert}^{p} ]}^{\frac{1}{p}} = D .$$

21. (canceled)
